(19) United States
(12) Patent Application Publication
(10) Pub. No.: US 2026/0002605 A1
(43) Pub. Date: Jan. 1, 2026

(54) SOLENOID VALVE WITH IMPROVED OPENING AND CLOSING SPEED, FLUID CONTROL SYSTEM AND FLUID CONTROL METHOD USING THE SAME

(71) Applicant: UIF (University Industry Foundation), Yonsei University, Seoul (KR)

(72) Inventors: Jun Young YOON, Seoul (KR); Bo Min KANG, Seoul (KR); Kyu Jin KANG, Seoul (KR); Kang Hee LEE, Seoul (KR); Byung Wook JEON, Seoul (KR)

(73) Assignee: UIF (University Industry Foundation), Yonsei University, Seoul (KR)

(21) Appl. No.: 19/252,266

(22) Filed: Jun. 27, 2025

(30) Foreign Application Priority Data
Jul. 1, 2024 (KR) 10-2024-0086483

(51) Int. Cl. F16K 31/08; F16K 31/06

(52) U.S. Cl. CPC F16K 31/082; F16K 31/0644; F16K 31/0679

(57) ABSTRACT

The solenoid valve includes a valve housing having a fluid flow path defined therein and having a fluid inlet and a fluid outlet fluid-communicating with the fluid flow path; a first magnetic portion received in the valve housing and having a partial annular shape having a hollow defined therein; a first coil portion received in the hollow of the first magnetic portion; a second magnetic portion received in the valve housing and having a partial annular shape having a hollow defined therein; a mover received in the valve housing and configured to perform a pivotal or translational motion under a magnetic force applied from the first magnetic portion or the second magnetic portion; and a permanent magnet received in the valve housing and disposed on the first coil portion so as to contact the first coil portion.

### CROSS-REFERENCE TO RELATED APPLICATION

This application claims priority from Korean Patent Application No. 10-2024-0086483 filed on Jul. 1, 2024 in the Korean Intellectual Property Office, and all the benefits accruing therefrom under 35 U.S.C. 119, the contents of which in its entirety are herein incorporated by reference.

### BACKGROUND

### Field

The present disclosure relates to a solenoid valve with an improved opening/closing speed, a fluid control system using the same, and a fluid control method using the same. Specifically, the present disclosure relates to a high-speed solenoid valve capable of replacing a restoring force of a spring using a magnetic reluctance-based force between magnetic bodies by a permanent magnet and generating a large torque under the same current using reinforcement or cancellation of magnetic field lines, thereby operating at a high speed.

### Description of Related Art

A high-speed solenoid valve that adjusts the opening and closing state of the flow path under an electromagnetic force generally includes a spring element. In an example, in the case of VX2 Series N.C. type (Direct Operated Solenoid Valve) of the SMC Corporation, when no current is applied to the coil, the flow path cap is pushed by the elastic force of the spring to block the flow path hole to maintain a closed state, whereas when the current is applied thereto, the electromagnetic force of the coil greater than the elastic force is generated in a direction opposite to a direction toward the cap to open the flow path. In the case of this technology, since the spring is further compressed in the process of pulling the cap when the current is applied to the coil, the elastic force that prevents the movement is further increased. Therefore, there is a disadvantage that the resultant force acting on the flow path stopper or cap is reduced.

In addition, in the solenoid valve using the spring, a mechanical space for installing a bulky spring is required, thereby complicating a structure of the valve. In addition, it is necessary to periodically maintain and repair the spring due to a change in a spring constant according to the number of times of uses, mechanical friction, and wear.

### SUMMARY

However, in accordance with the present disclosure, the magnetic field lines of the permanent magnet are used instead of the spring, such that the magnetic field lines of the permanent magnet can be cancelled with the magnetic field lines of the coil in the process of opening the valve when the current is applied, thereby removing the force obstructing the movement of the valve. Therefore, compared with the prior art, the resultant force acting on the flow path stopper or cap is increased under the same electromagnetic force, thereby generating a greater acceleration.

Furthermore, according to the present disclosure, the structure of the valve may be simplified using the permanent magnet instead of the spring. In addition, there is an advantage in that the valve is easily maintained and repaired due to the constant magnitude of the magnetic force of the permanent magnet.

There are prior patents using the magnetic force of the permanent magnet. However, there are differences thereof from the present disclosure. For example, in the case of Korean Patent Application Number 10-2022-0015650, a forward current is applied to the coil to generate a contact state between the armature and the magnetic core such that the flow path is closed. Then, the current application is stopped. However, the contact state may be maintained due to the magnetic force of the permanent magnet. That is, the permanent magnet acts to maintain the flow path closed state without applying the current to the coil. This purpose thereof is different from the purpose of the permanent magnet of the present disclosure contributing to the highly accelerated operation of the valve due to the increase in the total or resultant force.

Further, in the case of Korean Patent Application Number 10-2022-0051297, the contact state between the armature and the magnet core is established when a constant current is applied to the coil such that the flow path is opened. Then, the current application is stopped. However, the contact state may be maintained due to the magnetic force of the permanent magnet greater than the elastic force of the elastic spring. That is, the permanent magnet acts to maintain a flow path open state even without applying the current to a coil. This purpose thereof is also different from the purpose of the permanent magnet of the present disclosure as described above.

Thus, a purpose of the present disclosure is to improve the opening/closing speed of the solenoid valve and facilitate the maintenance thereof. To this end, the permanent magnet is used instead of the spring to simplify the structure and to generate the greater acceleration when the current is applied. The present solenoid valve may contribute to increasing the productivity of manufacturing equipment, and may help to reduce an operating cost thereof by extending a maintenance period. In addition, the present solenoid valve having increased space efficiency has the possibility of being flexibly applied to various manufacturing environments.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

A first aspect of the present disclosure provides a solenoid valve with an improved opening and closing speed, the solenoid valve comprising: a valve housing having a fluid flow path defined therein and having a fluid inlet and a fluid outlet fluid-communicating with the fluid flow path; a first magnetic portion received in the valve housing and having a partial annular shape having a hollow defined therein; a first coil portion received in the hollow of the first magnetic portion; a second magnetic portion received in the valve housing and having a partial annular shape having a hollow defined therein, wherein the second magnetic portion is spaced from the first magnetic portion; a second coil portion received in the hollow of the second magnetic portion; a mover received in the valve housing and configured to perform a pivotal or translational motion under a magnetic force applied from the first magnetic portion or the second magnetic portion; and a permanent magnet received in the valve housing and disposed on the first coil portion so as to contact the first coil portion, wherein the mover is configured to move under the magnetic force applied from the first magnetic portion or the second magnetic portion such that the fluid inlet and the fluid outlet fluidly communicates with each other through the fluid flow path or are fluidly isolated from each other.

In accordance with some embodiments of the solenoid valve, each of the first magnetic portion and the second magnetic portion has a partial cut-out at which the partial annular shape thereof is broken.

In accordance with some embodiments of the solenoid valve, the permanent magnet is received in the partial cut-out of the first magnetic portion and contacts one end of the partial annular shape.

In accordance with some embodiments of the solenoid valve, the partial annular shape of each of the first magnetic portion and the second magnetic portion has first and second ends in the partial cut-out, wherein a first end of the partial annular shape of the first magnetic portion faces a first end of the partial annular shape of the second magnetic portion.

In accordance with some embodiments of the solenoid valve, the permanent magnet contacts the second end of the partial annular shape of the first magnetic portion, wherein the mover is configured to pivot to contact or be removed from the permanent magnet.

In accordance with some embodiments of the solenoid valve, the mover is removed from the permanent magnet such that the fluid inlet and the fluid outlet are fluidly isolated from each other, wherein the mover contacts the permanent magnet such that the fluid inlet and the fluid outlet fluidly communicate with each other through the fluid flow path.

In accordance with some embodiments of the solenoid valve, the mover contacts the permanent magnet such that the fluid inlet and the fluid outlet are fluidly isolated from each other, wherein the mover is removed from the permanent magnet such that the fluid inlet and the fluid outlet fluidly communicate with each other through the fluid flow path.

In accordance with some embodiments of the solenoid valve, the mover performs the pivotal motion around a fixed point.

In accordance with some embodiments of the solenoid valve, at the fixed point, the mover is coupled to the valve housing via a pivot in a pivotable manner.

A second aspect of the present disclosure provides a method for controlling a solenoid valve using a controller, wherein the solenoid valve includes the solenoid valve accordance with some embodiments of the present disclosure, wherein the method comprises: a first step of controlling, by the controller, current application such that the current is not applied to the first coil portion and the second coil portion such that the mover contacts the permanent magnet; and a second step of controlling, by the controller, current application such that the current is applied to the first coil portion to weaken a magnetic field line of the first magnetic portion and/or is applied to the second coil portion such that the second magnetic portion applies an attractive-force to the mover, such that the mover is removed from the permanent magnet.

In accordance with some embodiments of the method for controlling the solenoid valve, in the second step, the mover is removed from the permanent magnet such that the fluid inlet and the fluid outlet are fluidly isolated from each other, wherein in the first step, the mover contacts the permanent magnet such that the fluid inlet and the fluid outlet fluidly communicate with each other through the fluid flow path.

In accordance with some embodiments of the method for controlling the solenoid valve, in the first step, the mover contacts the permanent magnet such that the fluid inlet and the fluid outlet are fluidly isolated from each other, wherein in the second step, the mover is removed from the permanent magnet such that the fluid inlet and the fluid outlet fluidly communicate with each other through the fluid flow path.

In accordance with some embodiments of the method for controlling the solenoid valve, the mover performs the pivotal motion around a fixed point.

A third aspect of the present disclosure provides a fluid control system comprising: the solenoid valve in accordance with some embodiments of the present disclosure; and a controller configured to control the solenoid valve.

A fourth aspect of the present disclosure provides a fluid control method comprising performing the solenoid valve control method in accordance with some embodiments of the present disclosure.

The effect of the present disclosure includes improving the opening/closing speed of the solenoid valve, facilitating the maintenance thereof, and simplifying the structure thereof. Replacing the spring inducing the restoring force with the permanent magnet may allow unnecessary resistance to be reduced when the current is applied, which may contribute to increasing the productivity of the manufacturing equipment. Further, the solenoid valve of the present disclosure provides the possibility of reducing operating costs by increasing space efficiency and extending a maintenance period. These effects can help to increase overall operational efficiency through flexible application of the present the solenoid valve in various manufacturing environments.

As the manufacturing industry is automated, the solenoid valve that can be electrically controlled at high speed is becoming a key component of many manufacturing equipment, such as EUV generation equipment, air jet classifiers, and jet dispensers, etc. Therefore, since the high-speed operation of the solenoid valve is directly related to the productivity of such manufacturing equipment, it is important to increase the response speed of the valve. In accordance with the present disclosure, the magnetic force of the permanent magnet instead of the spring is used to remove the force that interferes with the movement of the valve, so that the solenoid valve can operate at a higher acceleration, thereby significantly increasing the productivity of the manufacturing equipment using the high-speed solenoid valve.

In addition, in the manufacturing equipment that is bulky and has a complex internal structure, space efficiency becomes important. Thus, it is important to miniaturize the size of core internal components. In accordance with the present disclosure, the valve structure may be simpler and smaller in that the bulky and complex spring is replaced with the permanent magnet. Therefore, when this feature is combined with the manufacturing equipment, the space efficiency of the manufacturing equipment may be further increased.

It is important to be able to use the manufacturing equipment continuously for a long time to improve the productivity of the manufacturing equipment. However, due to the nature of these mechanical equipment, the maintenance and repair thereof should be performed regularly. Therefore, it is important in terms of the productivity to operate the equipment having the larger maintenance and repair period. In accordance with the present disclosure, the permanent magnet generating the permanently constant force is used in place of the spring which needs to be periodically managed and replaced, such that the time period required for the maintenance and repair is greater, thereby contributing to the improvement of the productivity of the manufacturing equipment.

The effects of the present disclosure are not limited to the above-mentioned effects, and other effects not mentioned may be clearly understood by those skilled in the art from the following descriptions.

In addition to the above-described effects, the specific effects of the present disclosure will be described together while describing specific matters for implementing the embodiments of the present disclosure below.

### BRIEF DESCRIPTION OF THE DRAWINGS

FIG. 1 is an exploded view of a high-speed solenoid valve. This drawing shows how components are assembled with each other, and visually displays the arrangement of a valve housing, a fluid inlet, a fluid outlet, a coil unit, a fixed iron core unit, a permanent magnet, and a mover unit.

FIG. 2 is a cross-sectional view of a high-speed solenoid valve. This figure shows the internal structure of the valve, and clearly shows the arrangements of and interactions between the fluid inlet and the fluid outlet, the coil unit and the fixed iron core unit, and the mover unit. In particular, FIG. 2 illustrates a state of the NC valve in which the fluid outlet is closed in a state in which no current is applied.

FIG. 3 is a diagram illustrating an operating principle of a valve housing, a coil unit, a fixed iron core unit, a permanent magnet, and a mover unit. The figure illustrates how the valve operates through a method of controlling the fluid flow around the fluid inlet and fluid outlet and controlling the magnetic field line of the permanent magnet by applying a current to the coil unit.

FIG. 4 is a diagram illustrating a state corresponding to the upper left drawing of FIG. 3, as a normal state in which the valve is closed and the current is not applied. The drawing illustrates a state in which the magnetic field line of the permanent magnet induces a magnetic reluctance-based force between the magnetic field line adjusting fixed iron core portion and the magnetic field line adjusting mover portion to blocks the fluid outlet.

FIG. 5 is a diagram corresponding to the upper right drawing of FIG. 3 in a state in which the current is applied to open the valve while the valve is closed. This drawing illustrates a process of applying a current to the coil winding (hereinafter, the magnet magnetic field line adjustment coil winding) for adjusting the magnetic field line of the magnet to cancel the magnetic field line of the permanent magnet and applying a current to the coil winding (hereinafter, the mover magnetic field line adjustment coil winding) for adjusting the magnetic field line of the mover unit to move the mover unit to open the fluid outlet.

FIG. 6 is a diagram illustrating a state in which the fluid outlet is maintained in an open state which corresponds to a lower right drawing of FIG. 3. This drawing shows a process of applying an appropriate current to the magnet magnetic field line adjusting coil winding and the mover attractive-force adjusting coil winding so that the mover unit pivots in a clockwise direction such that the fluid outlet is maintained in an open state.

FIG. 7 is a diagram illustrating a state corresponding to the lower left drawing of FIG. 3 as the state in which the current applied for closing the valve while the fluid outlet is open is removed. This drawing shows a state in which the magnetic reluctance-based force disappears when the current applied to the mover attractive-force adjusting coil winding is removed, and the magnetic field line of the permanent magnet is generated again by removing the current applied to the magnetic field line adjustment coil winding, such that the mover pivots in a counterclockwise manner to block the fluid outlet and close the valve.

FIGS. 8 to 15 are diagrams illustrating various examples of the high-speed solenoid valve using a similar principle to the principle as described with reference to FIG. 1 to FIG. 7.

### DETAILED DESCRIPTION OF THE DISCLOSURE

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this disclosure, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when an element or layer is referred to as being “connected to”, or “coupled to” another element or layer, it may be directly connected to, or coupled to the other element or layer, or one or more intervening elements or layers may be present therebetween. In addition, it will also be understood that when an element or layer is referred to as being “between” two elements or layers, it may be the only element or layer between the two elements or layers, or one or more intervening elements or layers may also be present.

Further, as used herein, when a layer, film, area, plate, or the like is disposed “on” or “on top” of another layer, film, area, plate, or the like, the former may directly contact the latter or still another layer, film, area, plate, or the like may be disposed between the former and the latter. As used herein, when a layer, film, area, plate, or the like is directly disposed “on” or “on top” of another layer, film, area, plate, or the like, the former directly contacts the latter and still another layer, film, area, plate, or the like is not disposed between the former and the latter. Further, as used herein, when a layer, film, area, plate, or the like is disposed “beneath” or “under” another layer, film, area, plate, or the like, the former may directly contact the latter or still another layer, film, area, plate, or the like may be disposed between the former and the latter. As used herein, when a layer, film, area, plate, or the like is directly disposed “beneath” or “under” another layer, film, area, plate, or the like, the former directly contacts the latter and still another layer, film, area, plate, or the like is not disposed between the former and the latter.

In descriptions of temporal relationships, for example, temporal precedent relationships between two events such as “after”, “subsequent to”, “before”, etc., another event may occur therebetween unless “directly after”, “directly subsequent” or “directly before” is not indicated.

When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the terms “first”, “second”, “third”, and so on may be used herein to describe various elements, components, areas, layers and/or periods, these elements, components, areas, layers and/or periods should not be limited by these terms. These terms are used to distinguish one element, component, area, layer or section from another element, component, area, layer or period. Thus, a first element, component, area, layer or section as described under could be termed a second element, component, area, layer or period, without departing from the spirit and scope of the present disclosure.

When an embodiment may be implemented differently, functions or operations specified within a specific block may be performed in a different order from an order specified in a flowchart. For example, two consecutive blocks may actually be performed substantially simultaneously, or the blocks may be performed in a reverse order depending on related functions or operations.

The features of the various embodiments of the present disclosure may be partially or entirely combined with each other, and may be technically associated with each other or operate with each other. The embodiments may be implemented independently of each other and may be implemented together in an association relationship.

In interpreting a numerical value, the value is interpreted as including an error range unless there is no separate explicit description thereof. In the context of the present disclosure, the term “about” may mean about ±1%, about ±2%, about ±3%, about ±4%, about ±5%, about ±6%, about ±7%, about ±8%, about ±9%, or about ±10% of a value stated herein.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “embodiments,” “examples,” “aspects, and the like should not be construed such that any aspect or design as described is superior to or advantageous over other aspects or designs.

Further, the term ‘or’ means ‘inclusive or’ rather than ‘exclusive or’. That is, unless otherwise stated or clear from the context, the expression that ‘x uses a or b’ means any one of natural inclusive permutations.

The terms used in the description below have been selected as being general and universal in the related technical field. However, there may be other terms than the terms depending on the development and/or change of technology, convention, preference of technicians, etc. Therefore, the terms used in the description below should not be understood as limiting technical ideas, but should be understood as examples of the terms for illustrating embodiments.

Further, in a specific case, a term may be arbitrarily selected by the applicant, and in this case, the detailed meaning thereof will be described in a corresponding description period. Therefore, the terms used in the description below should be understood based on not simply the name of the terms, but the meaning of the terms and the contents throughout the Detailed Descriptions.

Throughout the present disclosure, “A and/or B” means A, B, or A and B, unless otherwise specified, and “C to D” means C inclusive to D inclusive unless otherwise specified.

“At least one” should be understood to include any combination of one or more of listed components. For example, at least one of first, second, and third components means not only a first, second, or third component, but also all combinations of two or more of the first, second, and third components.

Hereinafter, embodiments of the present disclosure will be described using the attached drawings. A scale of each of components as shown in the drawings is different from an actual scale thereof for convenience of illustration, and therefore, the present disclosure is not limited to the scale as shown in the drawings.

As used herein, a first direction, a second direction, and a third direction, or an X-axis direction, a Y-axis direction, and a Z-axis direction should not be interpreted only as having a geometric relationship with each other in which the first direction, the second direction, and the third direction are perpendicular to each other or the X-axis direction, the Y-axis direction, and the Z-axis direction are perpendicular to each other, but may be interpreted as having a geometric relationship with each other in which the first direction, the second direction, and the third direction interest each other at an angle other than 90 degrees (°) or the X-axis direction, the Y-axis direction, and the Z-axis direction are interest each other at an angle other than 90 degrees (°) within a range in which a configuration of the present disclosure may work functionally.

The solenoid valve according to an embodiment of the present disclosure is a solenoid valve with an improved opening/closing speed. The solenoid valve with an improved opening and closing speed includes: a valve housing having a fluid flow path defined therein and having a fluid inlet and a fluid outlet fluid-communicating with the fluid flow path; a first magnetic portion received in the valve housing and having a partial annular shape having a hollow defined therein; a first coil portion received in the hollow of the first magnetic portion; a second magnetic portion received in the valve housing and having a partial annular shape having a hollow defined therein, wherein the second magnetic portion is spaced from the first magnetic portion; a second coil portion received in the hollow of the second magnetic portion; a mover received in the valve housing and configured to perform a pivotal or translational motion under a magnetic force applied from the first magnetic portion or the second magnetic portion; and a permanent magnet received in the valve housing and disposed on the first coil portion so as to contact the first coil portion, wherein the mover is configured to move under the magnetic force applied from the first magnetic portion or the second magnetic portion such that the fluid inlet and the fluid outlet fluidly communicates with each other through the fluid flow path or are fluidly isolated from each other.

In the context of the present disclosure, the permanent magnet means a magnet that maintains a strong magnetic field by itself without receiving a magnetic field from the outside. When the solenoid valve operates, the permanent magnet replaces a spring and continuously provides a constant magnetic force, thereby contributing to improvement in the opening/closing speed of the valve.

In the context of the present disclosure, the meaning of the magnetic body or portion refers to a body or portion that does not generate a magnetic field by itself, but is magnetized when being exposed to an external magnetic field, thereby generating the magnetic field line. Such a magnetic body or portion may interact with the permanent magnet to control the motion of the mover unit, thereby adjusting the opening and closing of the solenoid valve.

In the context of the present disclosure, the meaning of the coil unit means a wound structure of an electric wiring that generates a magnetic field when a current flows therein. The coil unit generates or regulates the magnetic force through the current flowing therein, thereby inducing the motion of the mover unit to control the opening and closing of the solenoid valve.

In the context of the present disclosure, the meaning of a hollow means a space or a hole empty inside a material. The hollow receives therein the coil unit. Thus, the magnetic force generated from the coil unit may be effectively transmitted to the magnetic body or portion.

In the context of the present disclosure, the meaning of the shape or the form means a spatial arrangement of a material or a structure. This is used to indicate that the components of the solenoid valve are designed to be assembled with each other into a specific shape to achieve optimal performance.

Each of the first magnetic portion and/or the second magnetic portion may be formed into a partial annular shape having a hollow, wherein non-limiting examples of the annular shape having the hollow may include a doughnut shape, a toroidal shape, a torus shape, a rectangular doughnut shape, an elliptical doughnut shape, an octagonal doughnut shape, and various other polygonal doughnut shapes modified therefrom. These different shapes provide different magnetic field distributions and mechanical properties, thereby enabling optimal design for specific applications of solenoid valves. For example, the rectangular doughnut type can increase the arrangement efficiency in a limited space.

In the context of the present disclosure, the meaning of the mover unit or the mover means a component that physically moves in response to an external magnetic force. The mover unit interacts with the magnetic body to control the opening and closing of the valve. This constitutes the core operating mechanism of the solenoid valve.

In the context of the present disclosure, the meaning of the valve housing refers to an outer structure that serves to protect internal components from an external environment. The valve housing receives therein all components of the solenoid valve, thereby contributing to increasing the stability and durability of the system.

In accordance with some embodiments of the solenoid valve, each of the first magnetic portion and the second magnetic portion has a partial cut-out at which the partial annular shape thereof is broken. The partial annular shape of each of the first magnetic portion and the second magnetic portion has first and second ends in the partial cut-out. The first and second ends may face each other. This broken shape allows the magnetic field lines between the magnetic bodies to be concentrated in a specific direction, and helps to control the attractive-force or repulsive force between the magnetic bodies. This is designed to allow the mover unit of the solenoid valve to pivot or translate more efficiently, and allows the opening and closing operation of the valve to be more precisely and quickly controlled.

In accordance with some embodiments of the solenoid valve, the permanent magnet is received in the partial cut-out of the first magnetic portion and contacts one end of the partial annular shape. Thus, even in a state in which no power is applied, the magnetic force of the permanent magnet may apply the constant force to the mover unit through the end of the partial cut-out. This allows the mover unit to maintain a stable position without power, thereby allowing the valve to continuously maintain either an open or closed state. This design provides the advantage of reducing power consumption, increasing system reliability, and making the maintenance easier.

In accordance with some embodiments of the solenoid valve, the partial annular shape of each of the first magnetic portion and the second magnetic portion has first and second ends in the partial cut-out, wherein a first end of the partial annular shape of the first magnetic portion faces a first end of the partial annular shape of the second magnetic portion. Thus, the spacing between the magnetic bodies or portions may be changed even with a motion by a small angle or distance of the mover unit, so that the opening and closing of the valve may be controlled. This makes the motion of the mover unit simpler and more precise, thereby enabling a rapid opening/closing operation while minimizing power consumption. In addition, such a design may improve the durability of the system by reducing the fatigue of the mover unit and help to optimize the overall performance of the solenoid valve.

In accordance with some embodiments of the solenoid valve, the permanent magnet contacts the second end of the partial annular shape of the first magnetic portion, wherein the mover is configured to pivot to contact or be removed from the permanent magnet. In this way, the mover unit may perform an effective opening/closing operation even with a small movement. This contact method allows the position of the mover unit to be precisely adjusted under the attractive-force or repulsive force between the magnetic bodies.

In accordance with some embodiments of the solenoid valve, the mover is removed from the permanent magnet such that the fluid inlet and the fluid outlet are fluidly isolated from each other, wherein the mover contacts the permanent magnet such that the fluid inlet and the fluid outlet fluidly communicate with each other through the fluid flow path. This makes it possible to quickly and accurately control the flow of fluid, and may help to increase the responsiveness of the system.

Alternatively, in accordance with some embodiments of the solenoid valve, the mover contacts the permanent magnet such that the fluid inlet and the fluid outlet are fluidly isolated from each other, wherein the mover is removed from the permanent magnet such that the fluid inlet and the fluid outlet fluidly communicate with each other through the fluid flow path. This configuration provides flexibility in the way in which the state of the flow path is switched, thereby allowing adaptation to various application situations.

In accordance with some embodiments of the solenoid valve, the mover performs the pivotal motion around a fixed point. The advantage of the case when the mover performs the pivotal motion is that the mover has a simpler structure and higher durability than when the mover performs the translational motion. The pivotal motion causes little friction and wear, and can generate a large force even with relatively small energy. In addition, the pivotal motion may be precisely controlled, and thus the opening and closing operation of the solenoid valve may be more accurately performed. These features may contribute to prolonging the life of the solenoid valve and reducing the maintenance period thereof.

In accordance with some embodiments of the solenoid valve, at the fixed point, the mover is coupled to the valve housing via a pivot in a pivotable manner. In the context of the present disclosure, the meaning of the pivot refers to a pin, point, or short shaft supporting the mover and fixed to the valve housing at the fixed point. The mover may pivot around the pivot which helps the mover unit to pivot stably and smoothly. This increases the structural stability of the solenoid valve and makes it possible to efficiently control the motion of the mover unit. The pivotal motion around the pivot can help improve energy efficiency as well as precise opening and closing control.

Further, another aspect of the present disclosure provides a method for controlling a solenoid valve using a controller, wherein the solenoid valve includes the solenoid valve as described above, wherein the method comprises: a first step of controlling, by the controller, current application such that the current is not applied to the first coil portion and the second coil portion such that the mover contacts the permanent magnet; and a second step of controlling, by the controller, current application such that the current is applied to the first coil portion to weaken a magnetic field line of the first magnetic portion and/or is applied to the second coil portion such that the second magnetic portion applies an attractive-force to the mover, such that the mover is removed from the permanent magnet. In one embodiment, the solenoid valve may be the solenoid valve according to the embodiment of the present disclosure described above.

In the first step, the mover unit may be subjected to the attractive force from and be in contact with the permanent magnet disposed on the first magnetic portion in a state in which power is not applied to the first coil portion and the second coil portion, thereby allowing the valve to maintain a specific initial state. This step stabilizes the initial position of the solenoid valve and allows the valve to be mainlined in the open or closed state without power consumption.

The function of the second step is to apply the power to the first coil portion to weaken the magnetic field line of the first magnetic portion and/or apply the power to the second coil portion to cause the second magnetic portion to pull the mover unit, thereby causing the mover unit to be removed from the permanent magnet but come into contact with the second magnetic body. This step serves to change the position of the mover unit to switch the state of the valve. That is, the flow of the fluid may be controlled by changing the valve to the open or closed state.

The method of controlling the solenoid valve as described above will become apparent in the non-limiting embodiments to be described below.

In accordance with some embodiments of the method for controlling the solenoid valve, in the second step, the mover is removed from the permanent magnet such that the fluid inlet and the fluid outlet are fluidly isolated from each other, wherein in the first step, the mover contacts the permanent magnet such that the fluid inlet and the fluid outlet fluidly communicate with each other through the fluid flow path. In this case, the power is not applied in the first step, such that the mover unit is subjected to the attractive force of the permanent magnet of the first magnetic portion and contacts the permanent magnet to block the flow path to maintain the closed state. Then, in the second step, the power is applied to the first coil portion and the second coil portion to cause the mover unit to move to the second magnetic material to open the flow path. Thus, the flow of fluid may be controlled by switching the state of the flow path via the application of power.

Alternatively, in accordance with some embodiments of the method for controlling the solenoid valve, in the first step, the mover contacts the permanent magnet such that the fluid inlet and the fluid outlet are fluidly isolated from each other, wherein in the second step, the mover is removed from the permanent magnet such that the fluid inlet and the fluid outlet fluidly communicate with each other through the fluid flow path. In this case, the power is not applied in the first step such that the mover unit is subjected to the attractive force of the permanent magnet of the first magnetic portion and contacts the permanent magnet to open the flow path and maintain the open state. Then, in the second step, the power is applied to the first coil portion and the second coil portion to cause the mover unit to be removed from the permanent magnet but contact the second magnetic material, thereby closing the flow path.

In accordance with some embodiments of the method for controlling the solenoid valve, the mover performs the pivotal motion around a fixed point.

Still another aspect of the present disclosure provides a fluid control system comprising: the solenoid valve; and a controller configured to control the solenoid valve. In one embodiment, the solenoid valve may be the solenoid valve according to the embodiment of the present disclosure described above. The system further includes a computer program which may include one or more instructions that cause the controller to perform the operations/methods according to various embodiments of the present disclosure when being loaded into a memory. That is, the controller may execute one or more loaded instructions to perform the operations/methods according to various embodiments of the present disclosure.

Such a fluid control system may efficiently control the flow of the fluid via a fast and precise opening and closing operation of the solenoid valve. The system may be used in various industrial fields, and in particular, can contribute to productivity improvement and energy saving in the manufacturing process.

Still yet another aspect of the present disclosure provides a fluid control method which may include performing the solenoid valve control method. In one embodiment, the solenoid valve control method may be the solenoid valve control method according to the above-described embodiment of the present disclosure. This fluid control method may contribute to optimizing the flow of fluid via the rapid and precise control of the solenoid valve.

Hereinafter, an embodiment of the present disclosure will be described. However, the embodiments described below are only examples of embodiments of the present disclosure, and the scope of the present disclosure is not limited to the following embodiments.

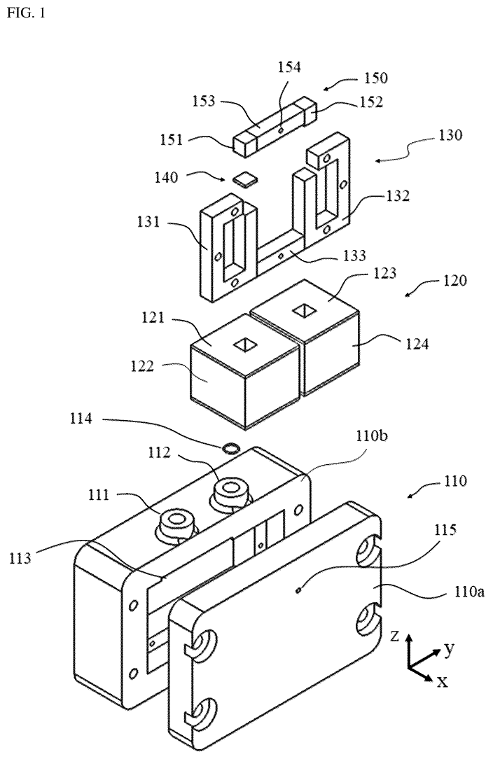

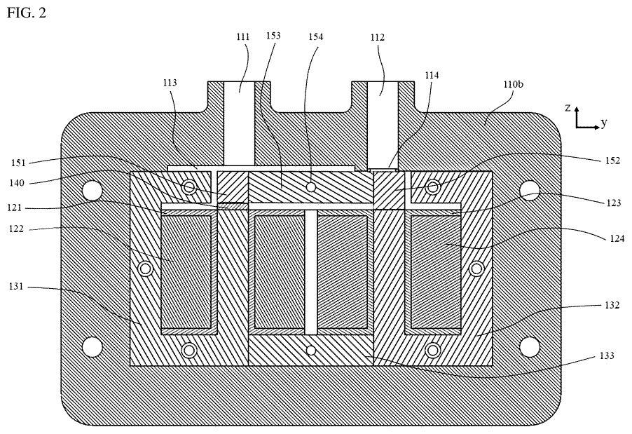

FIGS. 1 and 2 are respectively an exploded view and a cross-sectional views of a high-speed solenoid valve of the present disclosure.

The solenoid valve includes a valve housing 110 which includes an upper portion 110a and a lower portion 110b, and includes a fluid inlet 111 and a fluid outlet 112 defined therein. A spacing 113 between the fluid inlet and a mover (actuator) is a distance between the fluid inlet and the mover (actuator). A sealing rubber 114 prevents fluid from leaking through the fluid outlet. A mover pivotable connection shaft 115 assists pivotal movement of a mover unit 150.

The solenoid valve includes a coil unit 120 which includes a magnet magnetic field line adjusting coil jig 121 and a magnet magnetic field line adjusting coil winding 122, and further includes a mover attractive-force adjusting coil jig 123 and a mover attractive-force adjusting coil winding 124.

The solenoid valve includes a fixed iron core unit 130 which includes a magnet magnetic field line adjusting fixed iron core portion 131, a mover attractive-force adjusting fixed iron core portion 132, and an iron core connection portion 133.

The solenoid valve includes a permanent magnet 140 which is a core component that generates the magnetic force.

The solenoid valve includes the mover unit 150 which includes a magnetic field line adjustment mover portion 151, a mover attractive-force adjustment mover portion 152, a mover connection portion 153, and a shaft receiving hole 154. The mover pivotable connection shaft 115 is inserted into the shaft receiving hole 154 such that the mover unit 150 is pivotable around the mover pivotable connection shaft 115.

The lower portion 110b of the valve housing and the upper portion 110a of the valve housing are assembled with each other and are fastened with each other using a screw. In this regard, the sealing rubber 114 may be interposed between the upper portion 110a and the lower portion 110b to prevent the fluid from flowing out. The lower portion 110b has the fluid inlet 111 through which the fluid flows into the valve housing and the fluid outlet 112 through which the fluid exits out of the valve housing. The fluid having flowed into the fluid inlet 111 flows through the spacing 113 defined between the fluid inlet and the mover (actuator) and stays inside the valve housing 110. In a state in which the mover unit 150 blocks the fluid outlet 112, the mover unit 150 is removed away from the fluid outlet 112 under the operation of the mover attractive-force adjusting coil portion 124, such that the fluid is discharged through the fluid outlet 112. In this regard, the sealing rubber 114 is present in the fluid outlet 112 to prevent unnecessary outflow of fluid between the mover 150 and the fluid outlet 112.

FIG. 2 is a cross-sectional view of the high-speed solenoid valve of the present disclosure, and shows a state in which the fluid inlet 111 is present at a left side, the fluid outlet 112 is present at a right side, and the fluid outlet 112 is closed because current is not applied. FIG. 2 clearly shows how the fluid flows through the inside of the valve and how the components are arranged. As shown in the drawing, the fluid introduced through the fluid inlet 111 flows along a flow path inside the valve. However, in a state in which no current is applied, the mover unit 115 blocks the fluid outlet 112, and thus the fluid does not flow out. This state is designed to keep the valve basically closed. In addition, in the drawings, it is clearly shown how the components such as the coil units 121 and 122, the fixed iron core portions 131 and 132, and the mover portions 151 and 152 are arranged. This arrangement causes the mover unit to pivot when the current is applied, thereby opening or closing the fluid outlet.

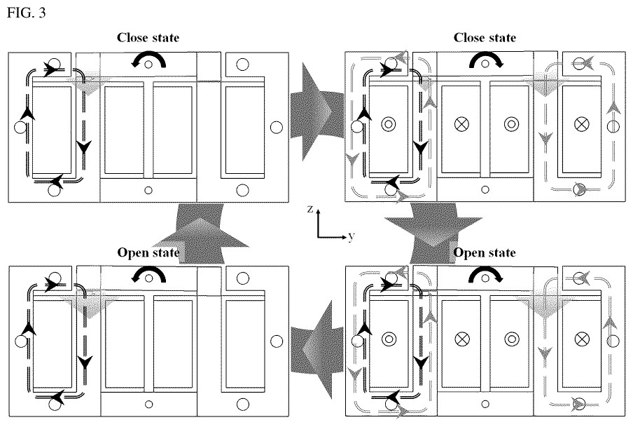

FIG. 3 illustrates an operation principle of the solenoid valve including the valve housing 110, the coil unit 120, the fixed iron core unit 130, the permanent magnet 140, and the mover unit 150. The permanent magnet 140 is present between the coil portion 121 and the mover portion (left) 151 adjacent to the fluid inlet 111. The magnetic field lines of the permanent magnet is adjusted using the coil portion 121. This may induce the movement of the mover unit 150 under the magnetic field line to control the opening and closing of the valve. The coil portion 123 and the mover portion 152 (right) adjacent to the fluid outlet 112 serve to open and close the fluid outlet 112 by adjusting the magnetic reluctance-based force between the mover unit 150 and the fixed iron core 130. The magnetic reluctance-based force is a force generated from the spacing between the magnetic bodies and the flow of the magnetic field line. Under the magnetic reluctance-based force, the mover unit may move in a desired direction to change the state of the valve.

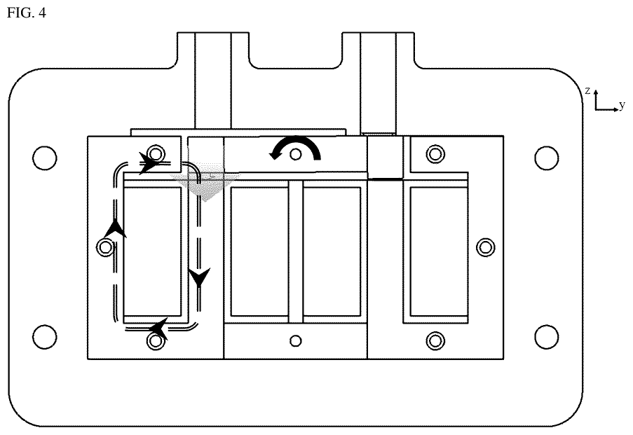

FIG. 4 shows a state in which the valve is closed as the upper left state of FIG. 3 and is in a normal state without the current application. Since the permanent magnet 140 is attached to the magnetic field line adjusting fixed iron core portion 131, the magnetic field line of the permanent magnet flows to the magnetic field line adjusting mover portion 151, and thus the attractive-force is generated to reduce the spacing between the magnetic field line adjusting fixed iron core portion 131 and the magnetic field line adjusting mover portion 151 due to the magnetic reluctance-based force. Therefore, a torque is generated in a +x direction, such that the mover unit pivots in the left direction, thereby maintaining a state in which the fluid outlet 112 is blocked. In this state, the valve maintains the closed state so that the fluid does not flow through the fluid outlet 112. In a state in which no current is applied, the magnetic field line of the permanent magnet induces the movement of the mover unit to maintain the valve in the closed state, so that the basic closed state may be maintained without energy consumption.

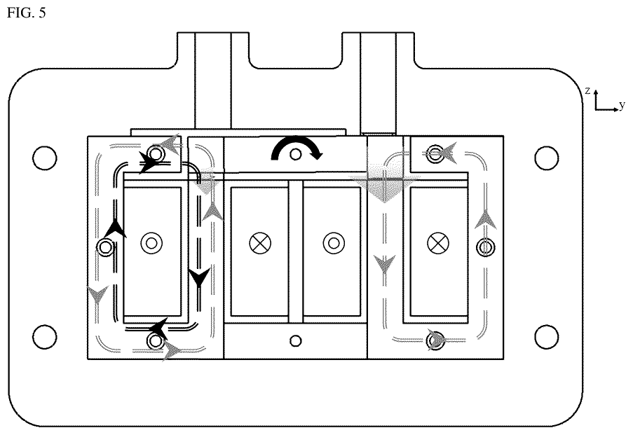

FIG. 5 shows a state in which the current is applied to open the valve while the valve is closed as the upper right state of FIG. 3. When the current is applied to the magnetic field line adjusting coil winding 122 wound around the magnetic field line adjusting coil jig 121, a magnetic field line is generated under the current. In this regard, when the current is applied in a direction to cancel the magnetic field line generated from the permanent magnet 140, a net flux in the gap between the magnetic field line adjusting fixed iron core portion and the magnetic field line adjusting mover portion due to the permanent magnet 140 decreases such that the magnetic reluctance-based force decreases. Accordingly, when an appropriate current is applied to the magnetic field line adjusting coil winding 122, the torque acting in the +x direction maintaining the closed state as described in FIG. 4 does not act.

When the current is applied to the mover attractive-force adjusting coil winding 124 wound around the mover attractive-force adjusting coil jig 123, the magnetic field line is generated under the current. In addition, the magnetic field line flows through the mover attractive-force adjusting fixed iron core portion 132 and the mover attractive-force adjusting mover portion 152 as two magnetic bodies. Similarly, the attractive-force is generated to reduce a spacing between the mover attractive-force adjusting fixed iron core portion 132 and the mover attractive-force adjusting mover portion 152 under the magnetic reluctance-based force. Therefore, the torque is generated in a −x direction such that the mover pivots in the clockwise direction. In this regard, the pivotal motion force is larger as the magnitude of the current is larger.

Each of the magnet magnetic field line adjustment fixed iron core portion 131 and the mover attractive-force adjustment fixed iron core portion 132 is made of a magnetic material through which the magnetic field line flows well. The iron core connection portion 133 disposed therebetween is made of a non-magnetic material through which the magnetic field line does not flow well. As a result, the magnetic field lines respectively flowing through the magnet magnetic field line adjusting fixed iron core portion 131 and the mover attractive-force adjusting fixed iron core portion 132 may act independently of each other. Similarly, each of the magnetic field line adjusting mover portion 151 and the mover attractive-force adjusting mover portion 152 is made of a magnetic material through which the magnetic field line flows well. The mover connection portion 153 disposed therebetween is made of a non-magnetic material. Thus, the magnetic field lines respectively flowing through the magnetic field line adjusting mover portion 151 and the mover attractive-force adjusting mover portion 152 may act independently of each other.

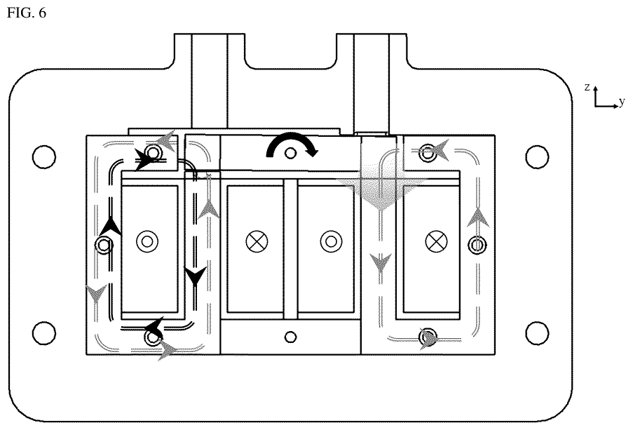

FIG. 6 shows a state in which the fluid outlet 112 is maintained in an open state as the lower right state of FIG. 3. An appropriate current is applied to the magnetic field line adjusting coil winding 124 to cancel the magnetic field line of the permanent magnet 140, thereby canceling the torque acing in the +x direction. Only the torque acting in the −x direction is generated from applying the current to the mover attractive-force adjusting coil winding 124, thereby maintaining an open state of the valve. In this state, the current is applied to the magnet magnetic field line adjusting coil winding 122 to cancel the magnetic field line of the permanent magnet, thereby removing the force under the mover unit moves in the +x direction. At the same time, the current is applied to the mover attractive-force adjusting coil winding 124 to generate the torque acting in the −x direction, so that the mover unit pivots in a clockwise direction to maintain a state in which the fluid outlet is opened. Thus, the fluid outlet 112 is maintained in an open states, and the fluid can flow freely.

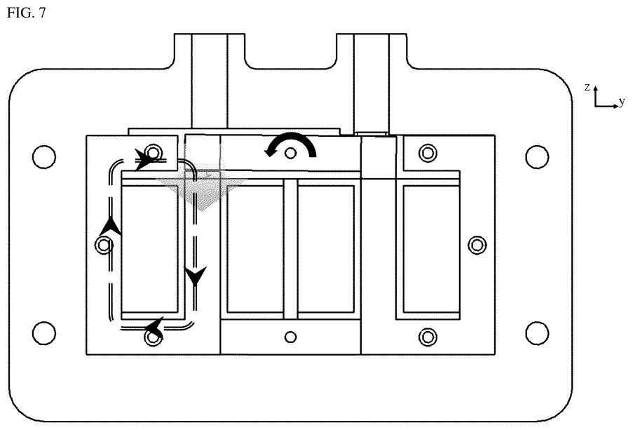

FIG. 7 shows the lower left state of FIG. 3 in which the current applied for closing the valve has been removed while the fluid outlet 112 is open. When the current applied to the mover attractive-force adjusting coil winding 124 has been removed, the magnetic field line disappears, and the magnetic reluctance-based force between the mover attractive-force adjusting fixed iron core portion 132 and the mover attractive-force adjusting mover portion 152 disappears, so that the torque acing in the −x direction does not act. At the same time, the magnetic field line resulting from the current application that has canceled out the magnetic field line of the permanent magnet 140 is removed by removing the current applied to the magnetic field line adjusting coil winding 122, such that the magnetic reluctance-based force between the magnetic field line adjusting fixed iron core portion 131 and the magnetic field line adjusting mover portion 151 is generated again, thereby generating the torque (restoring force) acing in the +x direction. Therefore, the mover unit pivots in the counterclockwise direction such that the fluid outlet 112 is blocked again to restore the valve to a closed state. In this process, the mover unit naturally returns to its original position as the current is removed and blocks the fluid outlet. This allows the valve to be maintained in a closed state without power consumption, thereby increasing the energy efficiency of the system and rapidly controlling the flow of fluid as needed.

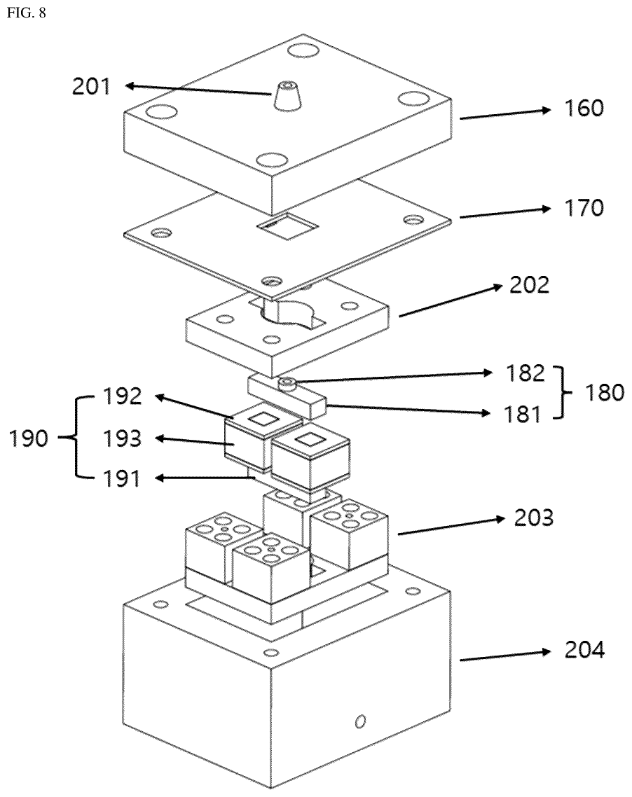

FIG. 8 is a diagram illustrating an example of a valve using a similar principle as that disclosed above with reference to FIG. 1 to FIG. 7. Referring to FIG. 8, the valve is composed of several components. FIG. 8 shows how the components are assembled with each other. A permanent magnet housing 160 is disposed at an upper end level, and a damping unit 170 is disposed under the permanent magnet housing. The damping unit is coupled to a movable portion 180 and serves to buffer the movement of the movable portion. The movable portion 180 is composed of an iron core 181 and a tip 182, and the tip is made of a rubber material so that it may move flexibly. A coil arm and a valve housing 190 include a U-shaped core 191, a coil bobbin 192, and a coil 193. This part serves to generate magnetic force under the current application. The coil bobbin 192 is a structure surrounding the coil, and the coil 193 generates a magnetic field when a current flows therein.

A nozzle 201 provides a passage through which the fluid flows, and the movable portion guide 202 guides the movable portion to move in the correct path. A coil adapter 203 serves to connect the coil and other components to each other, and a lower housing 204 serves to support and protect the components thereon.

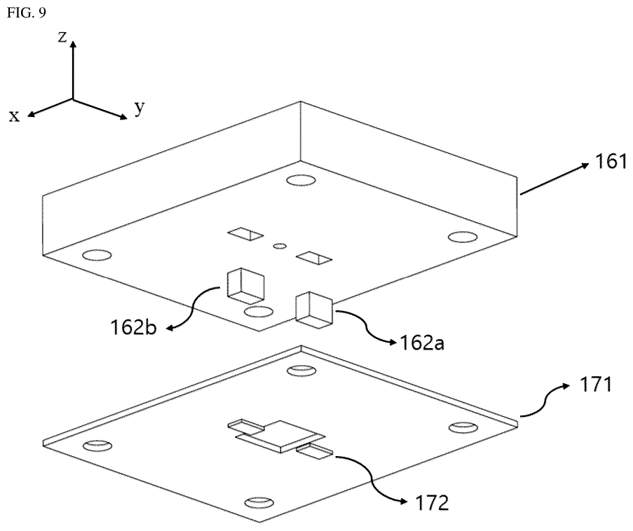

FIG. 9 is a diagram illustrating an example of a valve using a similar principle as that disclosed above with reference to FIG. 1 to FIG. 7. Referring to FIG. 9, the valve includes the permanent magnet housing 160 and the damping unit 170, and FIG. 8 shows how the permanent magnet housing 160 and the damping unit 170 are coupled to each other. The permanent magnet housing 160 includes a housing portion 161 and permanent magnets 162a and 162b. The housing portion 161 constitutes an outer appearance of the valve and serves to protect internal components. The permanent magnet 162a is positioned at one side in the Y direction of the housing, and the permanent magnet 162b is positioned at the other side in the Y direction thereof. These two permanent magnets interact with each other which plays an important role in controlling the operation of the valve. The damping unit 170 includes an impact protection damper 171 and a damper 172. The impact protection damper 171 is made of aluminum, and absorbs an impact that may be generated when the valve operates to protect internal components from damage. The damper 172 is made of a rubber material, and additionally serves to absorb impact and buffer the movement of the movable portion.

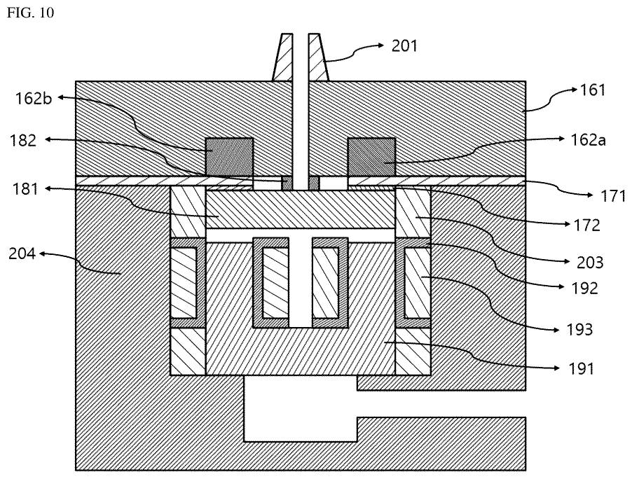

FIG. 10 is a diagram illustrating an example of a valve using a similar principle as that disclosed above with reference to FIG. 1 to FIG. 7. Referring to FIG. 10, this figure shows a cross-sectional view of the valve illustrating how internal components are arranged and the valve operates. The nozzle 201 is located at the upper end of the drawing, and the fluid is introduced into the valve through the nozzle. The permanent magnet housing unit 160 includes the housing 161 and the two permanent magnets 162a and 162b. These permanent magnets are respectively positioned at both opposing sides in the Y direction to generate the magnetic field. The damping unit 170 includes the impact protection damper 171 and the damper 172, which absorb an impact generated when the movable portion 180 moves to protect internal components from being damaged. The movable portion 180 includes the iron core 181 and the tip 182, and the tip is made of a rubber material and moves flexibly. The coil arm and the valve housing 190 are composed of the U-shaped core 191, the coil bobbin 192, and the coil 193. The coil bobbin 192 surrounds the coil 193, which generates a magnetic field when a current flows therein to induce the movable portion 180. The coil adapter 203 serves to connect the coil and other components to each other, and the lower housing 204 supports and protects the components thereon.

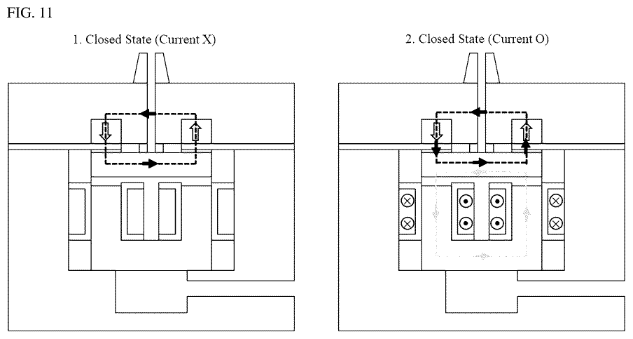

FIG. 11 is a diagram illustrating an example of a valve using a similar principle as that disclosed above with reference to FIG. 1 to FIG. 7. Referring to FIG. 11, the valve operation in two states is described: a state Closed State and Current X in which no current is applied and a state Closed State and Current O in which current is applied. The first drawing “Closed State (Current X)” shows a state in which the valve is closed in a state in which no current is applied. In this state, a magnetic field line generated from the permanent magnet generates a force that pushes the movable portion upwardly. This force causes the movable portion to block the flow path and maintain a state in which the flow of the fluid is blocked. Power is not consumed in this state, and the system is basically designed to maintain a closed state. The second drawing “Closed State (Current O)” shows a state in which the valve is closed while the current is applied. As current flows through the coil, a new magnetic field line is generated, and the magnetic field line cancels the magnetic field line of the permanent magnet to reduce the force pushing the movable portion upwardly. As a result, the amount of current flowing through the coil may be controlled such that the resultant force acting on the movable portion acts downwardly. Thus, the movable portion moves downwardly, and the movable portion opens the flow path so that the fluid may flow through the nozzle. This state is maintained while the current is flowing therein. When the current is cut off, the state returns to the basic closed state.

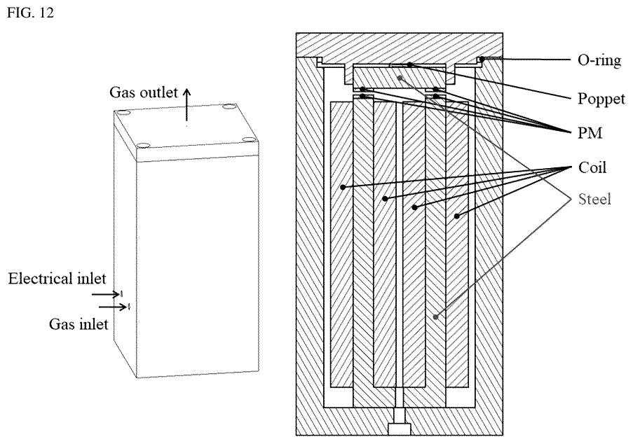

FIG. 12 is a diagram illustrating an example of a valve using a similar principle as that disclosed above with reference to FIG. 1 to FIG. 7. Referring to FIG. 12, the figure shows both an outer appearance and an inner structure of the valve. The left portion shows the outer appearance of the valve, and the fluid inlet, the fluid outlet, and the electricity inlet are shown. The right portion shows the internal structure of the valve in a cross-sectional view. The internal structure includes an O-ring, a poppet, a permanent magnet, a coil, and a steel. The O-ring serves to seal the fluid so that it does not leak, and the poppet is a component that controls the opening and closing of the valve to allow or disallow the flow of the fluid. The permanent magnet serves to stably maintain the position of the poppet by providing a constant magnetic field, and the coil serves to change the position of the poppet by generating a magnetic field when current flows therein. The steel supports the coil and the permanent magnet, and serves to constitute a path of the magnetic field. This drawing shows how the poppet moves when a current is applied or is not applied to the coil. When no current is applied, the poppet is maintained at a specific position under the force of the permanent magnet. When the current is applied thereto, the magnetic field generated from the coil cancels or strengthens the magnetic field of the permanent magnet to change the position of the poppet. The opening and closing of the valve may be controlled under this principle.

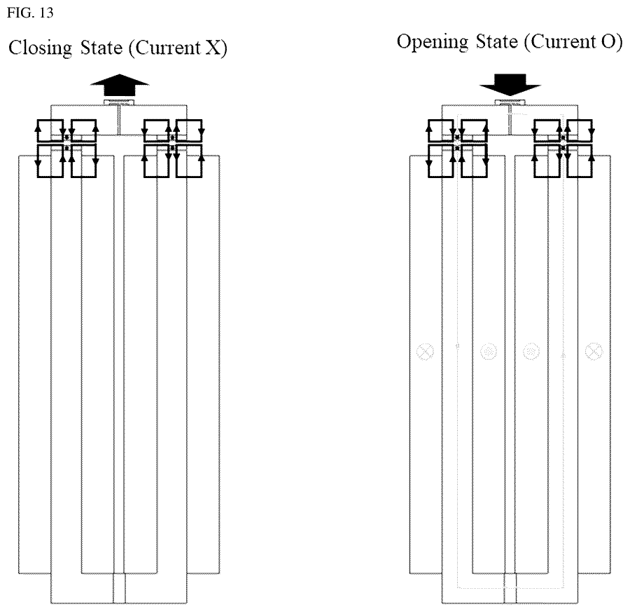

FIG. 13 is a diagram illustrating an example of a valve using a similar principle as that disclosed above with reference to FIG. 1 to FIG. 7. Referring to FIG. 13, this figure shows the internal structure and operation of the valve in a state in which no current is applied and in a state in which current is applied. The left drawing shows a state in which no current is applied. In this state, the magnetic field line generated from the permanent magnet pushes the poppet upwardly to maintain a state in which the flow path is blocked. The poppet is maintained at a fixed position under the force of the permanent magnet to block the flow of fluid. The right drawing shows a state in which a current is applied. In this state, a current flows through the coil, thereby generating a new magnetic field line. This magnetic field line cancels out or strengthens the magnetic field line of the permanent magnet, thereby generating a force to move the poppet downwardly. As a result, the poppet opens the flow path so that fluid can flow.

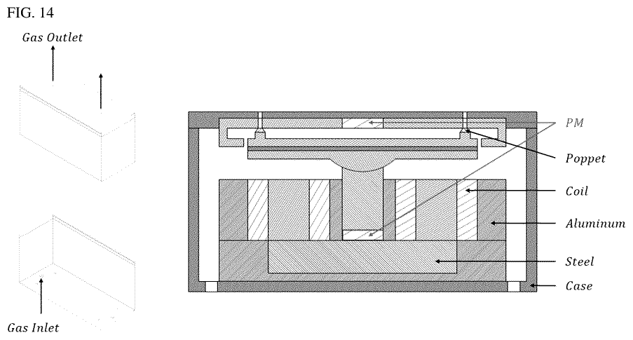

FIG. 14 is a diagram illustrating an example of a valve using a similar principle as that disclosed above with reference to FIG. 1 to FIG. 7. Referring to FIG. 14, the figure shows an outer appearance and an internal structure of the valve in a cross-sectional view. The left drawing shows the outer appearance of the valve, and the positions of the gas fluid inlet and the gas fluid outlet are shown. The right drawing shows the internal structure of the valve in a cross-sectional view. The internal structure includes a poppet, a coil, aluminum, steel, a casing, and a permanent magnet. The poppet is a component that controls the opening and closing of the valve, and allows or disallows the flow of fluid, and the coil plays a role of changing the position of the poppet by generating a magnetic field when a current flows therein. The aluminum is a lightweight material that provides structural support and thermal conductivity. The steel supports the coil and the permanent magnets and serves to constitute a path of a magnetic field. The casing protects and supports the components received therein, and the permanent magnet provides a constant magnetic field to stably maintain the position of the poppet.

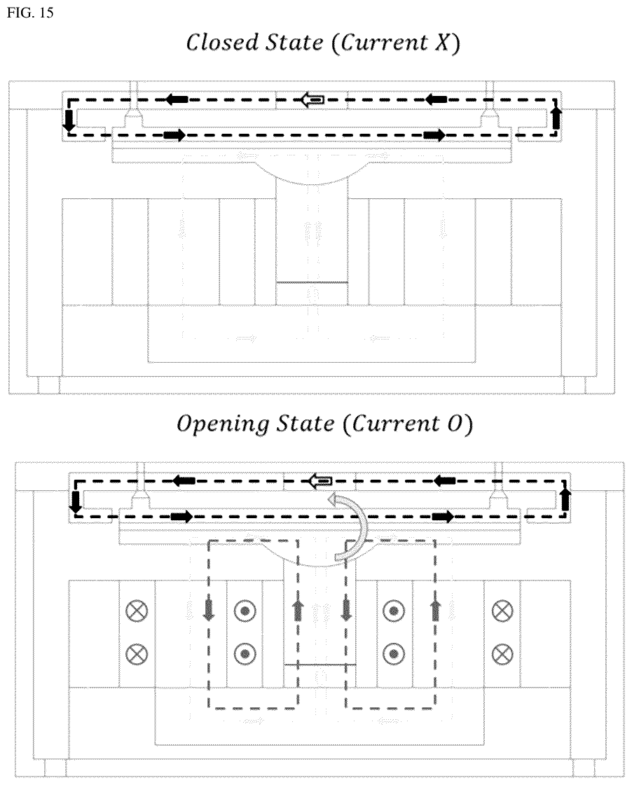

FIG. 15 is a diagram illustrating an example of a valve using a similar principle as that disclosed above with reference to FIG. 1 to FIG. 7. Referring to FIG. 15, the valve operation in two states is shown: a state Closed State and Current X in which no current is applied and a state Opening State and Current O in which current is applied. The first drawing Closed State (Current X) shows a state in which the valve is closed in a state in which no current is applied. In this state, the magnetic field line generated from the permanent magnet pushes the poppet upwardly to maintain a state in which the flow path is blocked. The poppet is maintained in a fixed position under the force of the permanent magnet to block the flow of fluid. The second drawing Opening State (Current O) shows a state in which the valve is open while the current is applied. In this state, the current flows in the coil, thereby generating the new magnetic field line. This magnetic field line cancels out or strengthens the magnetic field line of the permanent magnet, thereby generating the force to move the poppet downwardly. As a result, the poppet opens the flow path so that fluid can flow.

In accordance with the present disclosure, the attractive-force always existing due to the magnetic reluctance-based force between the magnetic bodies or portions using the permanent magnet replaces the restoring force of the spring. The high-speed solenoid valve of the present disclosure may employ the permanent magnet positioned at a position at which the magnetic field line can be effectively generated instead of the spring in which the physical structural change thereof always exists and the spring should contact the mover and the stator to cause a spatial constraint. Thus, it is easy to maintain and repair the solenoid valve of the present disclosure, compared to a conventional solenoid valve including the spring.

In addition, the restoring force of the spring requires an appropriate force to return the state of the valve from the open state to the closed state. In this regard, the greater the restoring force, the faster it can return to the closed state. However, even when a current is applied to open the valve, this restoring force is continuously generated, thereby interfering with the force to open the valve. Therefore, the restoring force of the spring should be properly adjusted. However, in accordance with the present disclosure, the permanent magnet is used as a spring substitute, and the magnetic field line of the magnet is adjusted based on the magnetic field line under the current, so that the restoring force may be applied only when the valve is closed, as shown in FIGS. 5 and 7. Therefore, the unnecessary force may be removed when the valve is opened, such that the greater torque may be generated under the same current, which means that a greater acceleration may be generated. In addition, the greater the magnetic field lines of the magnet, the greater the restoring force and the faster the valve can be closed. Even though the restoring force increases, this does not affect the torque to open the valve. Thus, the valve can be opened and closed in a faster manner than the conventional valve can be. In addition, the acceleration (angular acceleration) of the mover is proportional to the generated torque and inversely proportional to the rotation inertia of the mover. In this regard, the structure of the mover is simplified and the volume of the relatively dense magnetic portion is minimized. This allows for more efficient acceleration.

The present disclosure includes the configuration where the permanent magnet is positioned at a place where the magnetic field line may be generated from the permanent magnet as shown in FIGS. 3 to 7. In order to efficiently use the torque, the shape of the mover may be deformed, or the position of the pivot is variable. In addition, as shown in FIGS. 8 to 10, the principle that the magnetic reluctance-based force of the permanent magnet may replace the restoring force of the spring and the principle of efficiently using the magnetic field line of the permanent magnet via isolation of the magnetic field line may be also included in the technical idea of the present disclosure.

Although the embodiments of the present disclosure have been described above with reference to the accompanying drawings, the present disclosure may not be limited to the embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that the embodiments as described above are not restrictive but illustrative in all respects.

What is claimed is:

1. A solenoid valve with an improved opening and closing speed, the solenoid valve comprising:
a valve housing having a fluid flow path defined therein and having a fluid inlet and a fluid outlet fluid-communicating with the fluid flow path;
a first magnetic portion received in the valve housing and having a partial annular shape having a hollow defined therein;
a first coil portion received in the hollow of the first magnetic portion;
a second magnetic portion received in the valve housing and having a partial annular shape having a hollow defined therein, wherein the second magnetic portion is spaced from the first magnetic portion;
a second coil portion received in the hollow of the second magnetic portion;
a mover received in the valve housing and configured to perform a pivotal or translational motion under a magnetic force applied from the first magnetic portion or the second magnetic portion; and
a permanent magnet received in the valve housing and disposed on the first coil portion so as to contact the first coil portion,
wherein the mover is configured to move under the magnetic force applied from the first magnetic portion or the second magnetic portion such that the fluid inlet and the fluid outlet fluidly communicates with each other through the fluid flow path or are fluidly isolated from each other.

2. The solenoid valve of claim 1, wherein each of the first magnetic portion and the second magnetic portion has a partial cut-out at which the partial annular shape thereof is broken.

3. The solenoid valve of claim 2, wherein the permanent magnet is received in the partial cut-out of the first magnetic portion and contacts one end of the partial annular shape.

4. The solenoid valve of claim 3, wherein the partial annular shape of each of the first magnetic portion and the second magnetic portion has first and second ends in the partial cut-out,
wherein a first end of the partial annular shape of the first magnetic portion faces a first end of the partial annular shape of the second magnetic portion.

5. The solenoid valve of claim 4, wherein the permanent magnet contacts the second end of the partial annular shape of the first magnetic portion,
wherein the mover is configured to pivot to contact or be removed from the permanent magnet.

6. The solenoid valve of claim 5, wherein the mover is removed from the permanent magnet such that the fluid inlet and the fluid outlet are fluidly isolated from each other,
wherein the mover contacts the permanent magnet such that the fluid inlet and the fluid outlet fluidly communicate with each other through the fluid flow path.

7. The solenoid valve of claim 5, wherein the mover contacts the permanent magnet such that the fluid inlet and the fluid outlet are fluidly isolated from each other,
wherein the mover is removed from the permanent magnet such that the fluid inlet and the fluid outlet fluidly communicate with each other through the fluid flow path.

8. The solenoid valve of claim 5, wherein the mover performs the pivotal motion around a fixed point.

9. The solenoid valve of claim 8, wherein at the fixed point, the mover is coupled to the valve housing via a pivot in a pivotable manner.

10. A method for controlling a solenoid valve using a controller, wherein the solenoid valve includes the solenoid valve of claim 5,
wherein the method comprises:
a first step of controlling, by the controller, current application such that the current is not applied to the first coil portion and the second coil portion such that the mover contacts the permanent magnet; and
a second step of controlling, by the controller, current application such that the current is applied to the first coil portion to weaken a magnetic field line of the first magnetic portion and/or is applied to the second coil portion such that the second magnetic portion applies an attractive-force to the mover, such that the mover is removed from the permanent magnet.

11. The method of claim 10, wherein in the second step, the mover is removed from the permanent magnet such that the fluid inlet and the fluid outlet are fluidly isolated from each other,
wherein in the first step, the mover contacts the permanent magnet such that the fluid inlet and the fluid outlet fluidly communicate with each other through the fluid flow path.

12. The method of claim 10, wherein in the first step, the mover contacts the permanent magnet such that the fluid inlet and the fluid outlet are fluidly isolated from each other,
wherein in the second step, the mover is removed from the permanent magnet such that the fluid inlet and the fluid outlet fluidly communicate with each other through the fluid flow path.

13. The method of claim 10, wherein the mover performs the pivotal motion around a fixed point.

14. A fluid control system comprising:
the solenoid valve of claim 1; and
a controller configured to control the solenoid valve.

15. A fluid control method comprising performing the solenoid valve control method according to claim 10.
